(19) United States
(12) Patent Application Publication
(10) Pub. No.: US 2013/0248670 A1
(43) Pub. Date: Sep. 26, 2013

(54) Mechanism for Positional Adjustment of an Attached Device

(71) Applicant: Humanscale Corporation, New York, NY (US)

(72) Inventor: Manuel Saez, Brooklyn, NY (US)

(73) Assignee: Humanscale Corporation, New York, NY (US)

(21) Appl. No.: 13/896,121

(22) Filed: May 16, 2013

Related U.S. Application Data
(62) Division of application No. 11/150,870, filed on Jun. 10, 2005, now abandoned.
(60) Provisional application No. 60/578,546, filed on Jun. 10, 2004.

(51) Int. Cl. F16M 13/02

(52) U.S. Cl. CPC F16M 13/022
USPC 248/295.11

(57) ABSTRACT

The invention provides mechanisms useful for adjusting the positioning of an attached device, such as a display or input device. In one embodiment, the mechanism is a front end height adjustment mechanism comprising a track apparatus, a display mounting bracket, a sliding bracket, and a motion regulating device. In another embodiment, the mechanism comprises a device support arm, such as a monitor arm. The invention further provides a method for adjusting the positioning of a display or input device, such as a flat screen monitor, wherein the method comprises providing a mechanism of the invention, attaching the mechanism to a support, attaching a display or input device to the mechanism, and positionally adjusting the display or input device.

### CROSS-REFERENCE TO RELATED APPLICATIONS

This application claims the benefit of U.S. Provisional Application No. 60/578,546, filed Jun. 10, 2004, which is incorporated herein in its entirety.

### FIELD OF THE INVENTION

The present invention is generally directed to mechanisms useful for facilitating positional adjustment of an attached device. More particularly, the invention provides a height adjustment mechanism for use with an input device or a display device, such a video display. The mechanism allows for easy vertical adjustment of a device, placing the device in a position more ergonomically desirable for a user. The mechanism can further include components, such as a monitor arm, for facilitating horizontal adjustment of a device.

### BACKGROUND

With the technological innovation of the last 15 years, more and more individuals are spending an increasing amount of time using computers. Accordingly, computer users are spending an increasing amount of time sitting in front of a video display unit. This time encompasses activities including inputting data, viewing video display, and otherwise interacting with digital media.

The increasing amount of time associated with such activity has also been associated with various health problems, particularly stemming from improper posture. These problems include muscle strain, fatigue, and stress. According to experts in ergonomics, though, there are several easy and effective ways in which computer users can improve their physical comfort, fight fatigue, and reduce the risk of injuries from repetitive motions.

Posture is one area in which minor adjustments can quickly yield benefits. Even at home, but especially in a more stressful environment, like an office, users may force their bodies into rigid positions that result in fatigue, muscle strain, and, potentially, injury. Maintaining what experts refer to as optimal ergonomic positioning can increase energy levels and improve overall comfort, although it may take a few weeks before the results are noticeable. Good posture keeps the spine in what health professionals call the neutral position. Achieving a neutral posture while seated upright in a chair with good lumbar support entails lifting the rib cage away from the hips, tucking in the belly, pulling the shoulders back, centering the weight of the head atop the spine, and maintaining the lower back in a gentle C-shaped curve. Sustaining this position can help reduce muscle strain and relieve pressure on the lower back.

Beyond spinal posture, optimal ergonomic positioning requires tailoring the work area to fit the user's needs. Among things necessary to accomplish that is to position a video display being used at an appropriate eye level. Having the video display substantially at eye-level reduces muscle strain caused by the weight of the head leaning too far backward or forward.

The prior art discloses multiple methods for adjusting the position of a video display. Generally, positional changes are referred to in view of three adjustments: 1) vertical adjustment (i.e., adjusting the height of the display); 2) horizontal adjustment (i.e., adjusting the side-to-side position); and 3) tilt adjustment (i.e., adjusting the degree to which the display is tilted from the horizontal). In some cases, the prior art has attempted to supply a mechanism for all three positional adjustments. For example, U.S. Pat. No. 6,149,253 discloses a system comprising a display platform supported on a frame with a lift actuator, the display platform having a swivel base, a swivel actuator, a tilt actuator, and a display table. Systems such as this, while functional, are inefficient and bulky. Further, such systems are limited to use with larger displays, such as conventional computer monitors and conventional CRT television sets.

The present state of the art in video display has an emphasis on flat screen designs. This conforms to the market demand for higher performance, less space consumption, and a more streamlined appearance. To meet this demand, it is becoming common to have flat screen video displays attached to a work area with some manner of display arm. These display arms may be non-movable providing only a single viewing position. In such situations, vertical adjustment of the display requires detaching the display arm and physically raising or lowering the point of attachment to the work area. In other embodiments, display arms may be hinged providing for horizontal movement of the attached video display. Again, however, vertical adjustment is not possible without physically detaching the display arm and raising or lowering the point of attachment to the work area.

So-called “high tech” work areas demand flexibility for accommodating various users. Furthermore, the daily needs of individual users can also change. To be ergonomically beneficial, a video display should be capable of vertical adjustment to a most comfortable position.

Accordingly, it would be advantageous to have a mechanism allowing easy adjustment of the vertical position of a video display, such as a flat screen computer monitor. Such height adjustment mechanism should be capable of being mounted directly to a work station. Further, such height adjustment mechanism should be capable of being mounted in conjunction with a display arm or other mechanism allowing for further positional adjustment. Additionally, such height adjustment mechanism should be capable of use with a large variety of video displays or input devices without requiring additional attachment adapters.

### SUMMARY OF THE INVENTION

The present invention provides a positional adjustment mechanism that allow for easy adjustment of the position of a video display, such as a flat screen computer monitor, or an input device, such as a touchscreen. The positional adjustment mechanism provides height adjustment, lateral adjustment, and depth adjustment of the attached device. The mechanism can be a single mechanism or can be a combination of two or more mechanisms.

In one aspect, the invention is a front end height adjustment mechanism (FEA mechanism). In one particular embodiment, the FEA comprises a track, a sliding bracket adapted for vertical movement along the track, track friction reducers attached to the sliding bracket, a second bracket attached to the track and adaptable for mounting a device to the mechanism or attaching the mechanism to a support, and a compression gas spring.

According to another embodiment of the invention, the height adjustment mechanism comprises a track, a sliding bracket, at least one additional bracket adaptable for mounting a device to the mechanism or attaching the mechanism to a support, and a motion regulating device. An additional bracket can be connected to the track assembly or the sliding bracket. In one particular embodiment of the mechanism, a display or input device is attachable to the track assembly (or the sliding bracket), preferentially with a display attachment bracket. Further, according to one embodiment of the invention, the sliding bracket (or the track assembly) is capable of attachment to an external support, such as a display arm. In one preferred embodiment, the motion regulating device is a compression gas spring mounted in the track assembly and attached to the sliding bracket.

The FEA of the invention combines simplicity of design with a high level of effectiveness to provide a mechanism that allows for easy height adjustment of attached devices. In particular, the track assembly is preferentially comprised of an aluminum extrusion profile. Accordingly, the mechanism can be easily modified to accommodate video displays, or other devices, of differing sizes. Similarly, gas springs are readily available and can be provided in a different weight and/or a different stroke to accommodate devices of greater or lesser weight. Given the ease of modification, the front end height adjustment mechanism can be readily produced in different forms to be immediately adaptable to specific styles or models of video displays.

The present invention is a further improvement over the prior art in the ease of adjustment it provides. Preferentially, the gas spring used in the mechanism is of a weight that is substantially close to the force needed to move the weight of the attached device. Accordingly, there is less leverage encountered in the movement of the display. Furthermore, there is less friction between the external support bracket and the track apparatus. In one embodiment, such friction reduction is facilitated by the inclusion of glides, which act as friction reducers between the track apparatus and the external support bracket. Additionally, commercial lubricants can be used with the track to further reduce friction.

The present invention is also easily accommodated in most work and personal environments. The front end height adjustment mechanism is light in weight, sleek in appearance, and VESA® compliant. VESA® is a Flat Panel Monitor Physical Mounting Interface Standard (FPMPMI™) defining a standardized hole pattern. Manufacturers include this hole pattern on the back of their displays for mounting purposes. Typically, a VESA® hole pattern for displays under 23″ diagonal is sized either 75 mm×75 mm or 100 mm×100 mm. Being VESA® compliant, the front end height adjustment mechanism is readily adaptable to most flat-screen video displays generally available on the market.

According to another aspect of the invention, there is provided a method for positionally adjusting a display or input device. In one embodiment, the method comprises the steps of: providing a front end height adjustment mechanism comprising a track, a sliding bracket, at least one additional bracket adaptable for mounting a device to the mechanism or attaching the mechanism to a support and a motion regulating device; attaching the front end height adjustment mechanism to a support; attaching a display or input device to the front end height adjustment mechanism; and manually adjusting the position of the display or input device.

In another aspect of the invention, there is provided a device support arm. In one particular embodiment, the device support arm comprises a horizontal arm, a parallelogram arm, a dual pivot attachment connecting the horizontal arm to the parallelogram arm, a device attachment bracket, and a support attachment bracket.

The device support arm according to this embodiment is particularly beneficial in that the dual pivot attachment allows for 180° lateral movement of the horizontal arm to either side of the support arm. More particularly, the support arm is capable of folding at the dual pivot attachment such that the horizontal arm is positioned adjacent the parallelogram arm. Preferentially, the parallelogram arm portion of the device support arm includes a motion regulating device, such as a gas spring.

In another embodiment of the invention, the device support arm comprises a front arm link, a rear arm, an offset pivot attachment connecting the front arm link to the rear arm link, a device attachment bracket, and a support attachment bracket. In one preferred embodiment, the rear arm link is greater in length that the front arm link.

In this embodiment, the device support arm is again particularly beneficial in that the support arm is capable of folding at the offset pivot attachment such that the front arm link is positioned adjacent the rear arm link. The device support arm further preferentially includes a mechanism for locking the support arm into an extended position.

According to another aspect, the invention comprises a knobless bracket particularly useful in connection with a post for providing adjustable support of a device support arm on the post. In one particular embodiment, the bracket comprises a compressible ring-shaped cover having a central opening therethrough and a spring component contained within the ring-shaped cover. Preferably, the spring provides a gripping force toward the central opening in the ring shaped cover, and compression of the ring-shaped cover releases the gripping force of the spring. In another particular embodiment of the invention, there is provided a post for supporting a device support arm, and the post includes a bracket according to the above description.

The invention is further an improvement in the field in that positional adjustment can be maximized through various combinations of positional adjustment mechanisms working together in an ergonomically desirable manner. Accordingly, the invention further encompasses various combinations of a display arm, the FEA, or further components, such as a mounting post and a knobless mounting bracket.

### BRIEF DESCRIPTION OF THE DRAWINGS

FIG. 1 is a partially exploded front perspective view of one embodiment of a front end height adjustment mechanism of the invention;

FIG. 2 is a partially exploded rear perspective view of one embodiment of a front end height adjustment mechanism of the invention;

FIG. 3 is a perspective view of one embodiment of a slide bracket for use in a front end height adjustment mechanism of the invention;

FIG. 4 is a partially exploded top view of a front end height adjustment mechanism according to one embodiment of the invention;

FIG. 5 is a partially exploded top rear perspective view of one embodiment of a front end height adjustment mechanism according to the invention;

FIG. 6 is a partially exploded rear perspective view of a front end height adjustment mechanism according to another embodiment of the invention;

FIG. 7a is a rear perspective view of one embodiment of the front end height adjustment of the invention with the gas spring retracted and the sliding bracket in an up position;

FIG. 7b is the same view provided in FIG. 7a but with the gas spring extended and the sliding bracket in a down position;

FIG. 8 is a perspective view of one embodiment of a device support arm on a post useful for supporting the FEA of the invention;

FIGS. 8a-8l are various different embodiments of the device support arm illustrated in FIG. 8;

FIG. 9 is a perspective view of one embodiment of a device support arm according to the invention;

FIG. 9b is a top view of the device support arm of the embodiment of FIG. 9, wherein the arm is fully extended;

FIG. 9c is a perspective view of the device support arm of the embodiment of FIG. 9, wherein the arm is fully folded;

FIG. 10 is a side view of another embodiment of a device support arm according to the invention;

FIG. 10b is a detail view of the dual pivot attachment according to one embodiment of the device support arm of the invention;

FIG. 11 is a partially exploded perspective view of the embodiment of the device support arm according to FIG. 10;

FIG. 12 is a partially exploded detailed view of one embodiment of a device support arm of the invention illustrating the linkage between the parallelogram arm and the horizontal arm;

FIG. 13 is a partially exploded detailed view of one embodiment of a device support arm of the invention illustrating the linkage between the parallelogram arm and the support attachment bracket;

FIG. 14 is a perspective view of device support arm attached to a post an maintained in position on the post by a knobless bracket according to one embodiment of the invention;

FIG. 15a is a top perspective view of one embodiment of the knobless bracket of the invention; and

FIG. 15b is an exploded view of the embodiment of the knobless bracket shown in FIG. 15a.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should no be construed as limited to the embodiments set forth herein; rather, these embodiments are provided so that this disclosure will be thorough and complete, and will fully convey the scope of the invention to those skilled in the art. Like numbers refer to like elements throughout.

The present invention provides mechanisms generally useful for facilitating positional adjustment of a variety of attached devices. The inventive mechanisms are particularly useful for positional adjustment of different devices associated with electronic media input and output. In one embodiment, a display device, such as a video display (e.g., a flat-screen monitor), can be attached to the inventive mechanisms. In further embodiments, input devices, such as a touchscreen, can be attached to the positional adjustment mechanisms. Further, the mechanisms are useful for attachment thereto of a support, such as for supporting a computer keyboard, a laptop computer, a personal DVD player, or other input, display, or combination device.

For simplicity, the invention may be described in terms of allowing for positional adjustment of a display device, such as a television or flat screen monitor. It is understood, however, that the invention also encompasses positional adjustment of multiple other devices that could be easily attached to the mechanisms described herein. Accordingly, any description of the mechanisms in term of positional adjustment of a display device or monitor is not intended to be limiting to specific devices but is rather intended to generally describe the ability of the mechanisms of the invention to be used with a wide variety of devices.

In one aspect, the invention is a front end height adjustment mechanism. The FEA mechanism is preferably formed for attachment at a front-facing surface to a device, such as a display device, and is formed for attachment at a back-facing surface to a support, such as a wall structural member, mounting pole, display arm, or other similar structural support. The FEA mechanism is vertically aligned and includes motion regulating components internal to the structure that allows for adjustment of the attached display device in a vertical plane (i.e., height adjustment).

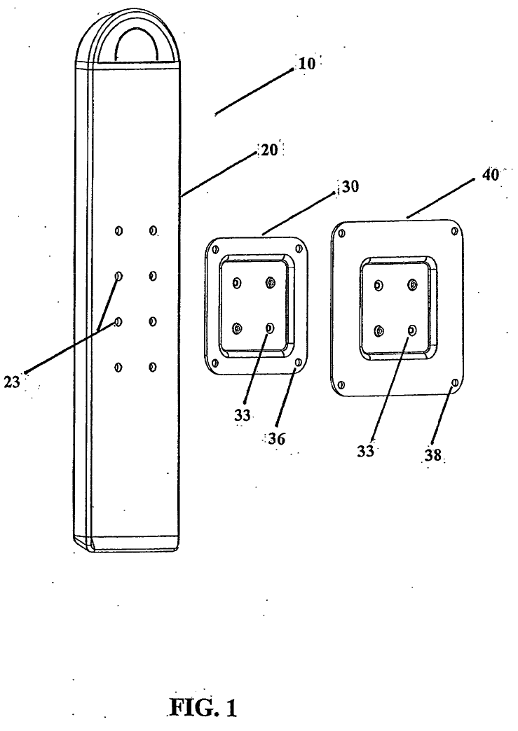

One embodiment of a front end height adjustment mechanism according to the invention is provided in FIG. 1, which shows a partially exploded front perspective view of the FEA mechanism. As seen in this figure, the FEA 10 externally mainly comprises a track apparatus 20, which further functions generally as an external functional and decorative covering for the FEA 10. Additionally provided on the front portion of the FEA 10 are a plurality of device mounting apertures 23, which allow for variable attachment of the desired device, such as a video display, at different vertical positions along the FEA. In the embodiment of FIG. 1, eight device mounting apertures are provide, four of the eight generally being used for attachment of the display device. Accordingly, in this embodiment, three different mounting positions are provided (i.e., the top two rows of apertures, the middle two rows of apertures, or the bottom two rows of apertures).

The display device can be mounted directly to the track 20 of the FEA 10 via the device mounting apertures 23. Alternately, the FEA can include a device mounting bracket 30, which can be attached via the device mounting apertures 23, again, at various positions. According to the embodiment shown in FIG. 1, the mounting apertures 23 are centrally located along the length of the FEA 10. Such positioning is intended to optimize height adjust in both the upward and downward positions; however, the invention is not limited to such positioning. The mounting apertures 23, or further mounting apertures, could be placed higher or lower on the FEA 10 as desired to maximize either upward or downward positioning. Therefore, the mounting bracket 30 could be attached to the track apparatus 20 at any position along the length of the track apparatus 20.

Optionally, the FEA 10 can further include one or more additional mounting components for increasing the spacing between the display device and the FEA 10. In one embodiment, a spacer bracket 40 can be used. Ideally, the spacer brackets and the mounting brackets used in the invention are interchangeable such that the spacer bracket could be attached directly to the FEA and the mounting bracket attached to the spacer bracket. Further, a variety of spacer devices could be used according to the invention.

Preferentially, the mounting bracket 30 (or the spacer bracket, in appropriate embodiments) is substantially standardized such that video displays generally available on the market are readily attachable to the FEA 10. In other words, it is preferred for the mounting bracket 30 to have a mounting hole pattern that is sized for easy mounting of a variety of input devices, display devices, and apparatuses for supporting such devices.

In a preferred embodiment according to the present invention, mounting bracket 30 (or the spacer bracket, if more external to the mechanism) is VESA® compliant. The Video Electronics Standards Association (VESA®) is an organization of technology based companies proposing standards for the video electronics market. One standard for mounting attachment of video displays is the VESA® Flat Display Monitor Interface standard or VESA® FDMI™. The VESA® FDMI™ Standard defines mounting interfaces, hole patterns, and associated cable/power supply locations for LCD monitors, plasma displays and other flat panel devices. Under this standard, VESA® compliant video displays are equipped with either a 75×75 mm mounting hole pattern or a 100×100 mm mounting hole pattern. Further, VESA® compliant mounting patterns may be found on other types of devices that could also be beneficially attached to the FEA mechanism of the invention for improving ergonomy related to vertical positioning of the attached device.

As seen in FIG. 1, the display bracket 30 has four inner holes 33 and four outer holes 36. The inner holes 33 are size to correspond to the device mounting apertures 23 on the FEA 10. The outer holes 36 are according to a 75×75 mm mounting hole pattern. Similarly, the spacer bracket 40 has four inner holes 33 and four outer holes 38. The outer holes 38 are according to a 100×100 mm mounting hole pattern. Alternately, the display bracket could have a 100×100 mm mounting hole pattern, and the mounting bracket could have a 75×75 mm mounting hole pattern, depending upon the particular need to be fulfilled by the various embodiments. Accordingly, the FEA mechanism can be customized for attachment to multiple standardized mounting protocols and can include additional adapters, such as the spacer bracket, for increasing the possible mountings. The FEA mechanism, being VESA® compliant, is readily adaptable for attachment to a large number of video displays.

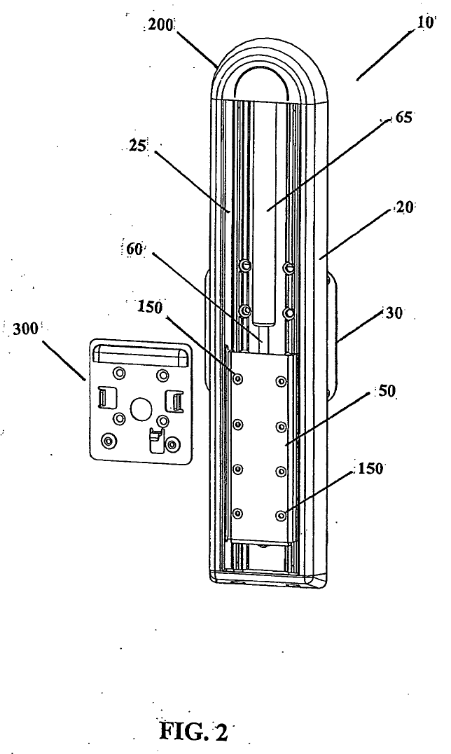

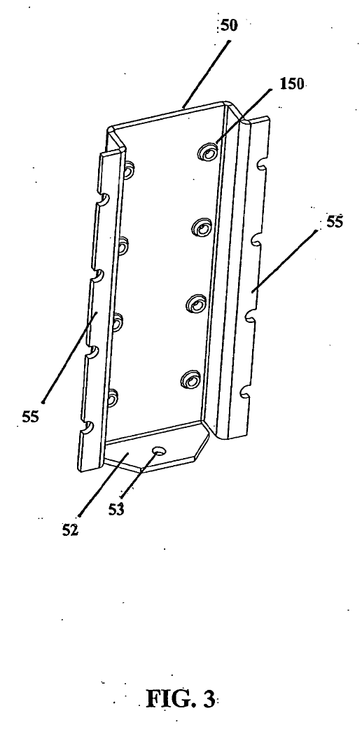

Further components of the front end height adjustment mechanism of the invention are illustrated in FIG. 2, which shows a partially exploded rear perspective view of the FEA 10. As seen in this embodiment, the track apparatus 20 has a substantially open interior for housing the further components of the FEA mechanism 10. Particularly seen in this view are the slide bracket 50 and the motion regulating device, which, in this embodiment, is a compression gas spring. The slide bracket 50 is connected to the lower end of the compression gas spring shaft 60, such connection being capable of bearing a sufficient weight to accommodate attached devices, such as flat screen monitors. Preferably, the slide bracket 50 is attached to the compression gas spring shaft 60 via a screw, bolt, rivet, weld, or the like. In one particular embodiment, shown in FIG. 3, the slide bracket 50 has a flange 52 with an aperture 53 for receiving a matching end of the compression gas spring shaft 60. In one embodiment, the aperture 53 is threaded for receiving a threaded end of the compression gas spring shaft 60. In another embodiment, the gas spring shaft 60 includes a pin for insertion into the aperture 53 in the slide bracket flange 52 that is held in place with a retaining clip.

Further illustrated in FIG. 2 is a ball joint support mounting plate 300, which is optionally included in the FEA invention. The ball joint support mounting plate 300 is only one type of mounting plate that could be used with the FEA. Various support mounting plates could be used depending upon the support to which the FEA is to be attached. The support mounting plate can be attached directly to the sliding bracket 50, such as by using screws, bolts, rivets, pins and clips, or the like, through interaction with sliding bracket apertures 150. As seen in FIG. 2, the sliding bracket 50 includes eight sliding bracket apertures according to this embodiment. This again allows for varying the range of height adjustment with the FEA by varying the height at which the FEA attaches to the support.

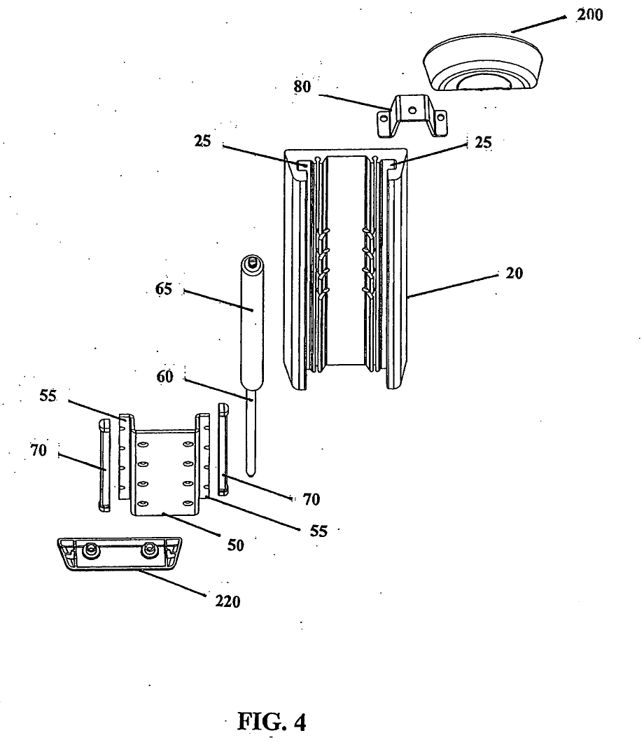

The slide bracket 50 is maintained in the track 20 through interaction with the track channels 25. FIG. 4 shows a partially exploded top perspective view of the FEA mechanism 10. Visible in this view is the shape of the slide bracket 50, particularly being characterized as U-shaped, and having side flanges 55 for interacting with track channels 25. In further embodiments, the slide bracket can be characterized as being C-shaped or, alternately, as being generally flat.

The side flanges 55 fit into the track channels 25, and the slide bracket 50 moves up and down the track 20, with the side flanges 55 moving freely along the track channels 25. To facilitate the free movement of the slide bracket 50 through the track 20, the invention further encompasses the inclusion of friction reducers, such as track glides 70, which conveniently fit over the outer edges of the side flanges 55, acting as a buffer between the side flanges 55 and the track channels 25. Desirably, the track glides 70 comprise a low friction material, or are coated with a low friction material, such as polytetrafluorethylene (PTFE), Teflon™, polyethylene, fluorinated ethylenepropylene copolymer (FEP), perfluoroalkoxy (PFA), or the like. Other methods for facilitating the movement of the slide bracket 50 along the track channels 25 are also encompassed by the present invention. For example, the side flanges 55 could be equipped with bearings for allowing roller movement through the track channels 25. Further friction reducing agents could also be used with the various embodiments of the invention. For example, lubricants could be used in the track channels 25 to further facilitate free movement of the slide bracket 50 up and down the track 20.

Desirably, the slide bracket moves freely along the track channels up and down at least a partial length of the track apparatus. Such free movement provides for smoothness of operation during height adjustment; however, unfettered movement of slide bracket would not allow for positional stability at a given height. Accordingly, the front end height adjustment mechanism of the invention further comprises a motion regulating device.

In one embodiment of the invention, as shown in FIG. 2, the motion regulating device is a compression gas spring, which comprises a gas spring shaft 60 and a gas spring chamber 65. Gas springs provide controlled and smooth lifting assistance for adjusting the height of a video display. Gas springs are particularly preferred according to the present invention because they are compact and lightweight, and a single gas spring can handle weights of up to 60 lbs, which is well within the range of weights of most video displays.

The use of gas springs as the motion regulating device according to the present invention is further advantageous because various gas springs can be employed to make the FEA mechanism adaptable to a number of different devices of different weights and sizes. Various compression gas springs are available allowing the present invention to be customized based on the use of springs having different stroke lengths and different weight ratings. Accordingly, the front end height adjustment mechanism of the invention can encompass a number of embodiments wherein the FEA is particularly rated for use with devices having weights falling within a plurality of variable ranges. For example, in one embodiment, the FEA may be rated for handling devices with weights up to about 20 pounds. In another embodiment, the FEA may be rated for handling devices with weights up to about 40 pounds. Various similar embodiments having different weight ratings are also encompassed by the invention.

The front end height adjustment mechanism of the present invention is further adaptable to use in different settings, and with a variety of devices, in that the FEA mechanism can be made in a variety of lengths to provide various ranges of adjustment. When a compression gas spring is used as the movement regulating device, the overall length of the front end height adjustment mechanism can be based upon the stroke length of the gas spring. Preferably, the gas spring has a stroke length of about 2 inches to about 10 inches, more preferably about 3 inches to about 9 inches, most preferably about 4 inches to about 8 inches. In one embodiment, a compression gas spring having a stroke length of about 6 inches is used. Such a spring would generally have an overall length of about 12 inches. The front end height adjustment mechanism of the present invention is particularly advantageous due to its compact nature. Accordingly, a front end height adjustment mechanism using a compression gas spring having an overall length of about 12 inches would have a final overall length of about 12-13 inches.

Additional, similar embodiments are also encompassed by the invention. Generally, when a gas spring is used as the motion regulating device, the FEA mechanism need only be of a length approximately equal to the maximum extended length of the gas spring. In one embodiment of the invention, a decorative top cap is attached to the top portion of the track. In addition to decoration, the top cap can also function as a grip or handle for moving the FEA to adjust the height of the attached device. In another embodiment, the FEA also includes a decorative bottom cap attached to the bottom portion of the track.

The compact design of the FEA is desirable in that it is easily incorporated into a minimalistic setting that is often required in work areas employing space saving equipment, such as flat screen computer monitors. Given the compact nature of the front end height adjustment mechanism, it easily attaches to the back portion of a video display, is generally smaller in overall height than the video display to which it is attached, and allows for height adjustment without taking up valuable work space. The overall length of the front end height adjustment mechanism can be greater or smaller than the example above to accommodate movement regulating devices of different sizes. Accordingly, when the FEA mechanism has a shorter overall length, it would be expected that the range of height adjustment would be lessened, and when the FEA mechanism has a greater overall length, it would be expected that the range of height adjustment would be increased.

In part, the effectiveness of the front end height adjustment mechanism of the invention arises from its basic construction. As can be seen in FIGS. 2-5, in one embodiment of the invention, the FEA comprises a track 20, a sliding bracket 50, and a gas spring, which includes a gas spring shaft 60 and a gas spring chamber 65. The sliding bracket 50 moves along the track channels 25. The sliding bracket 50 is fixedly attached at a bottom flange 52 to the bottom end of the gas spring shaft 60. The gas spring is fixedly attached to an upper portion of the track 20 via attachment of the upper end of the gas spring chamber 65 to a mounting strap 80. The gas spring, according to this embodiment, could also be inverted.

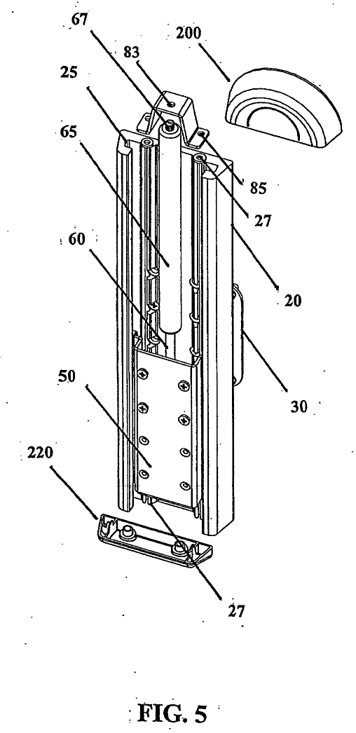

In one embodiment, as shown in FIG. 5, the top portion of the gas spring chamber 65 is fixedly attached to the mounting strap 80, such as with a pin 67 at the top surface of the gas spring chamber 65 through an aperture 83 in the mounting strap. The mounting strap 80 is further attached to an upper portion of the track 20 by commonly used attachment methods, such as bolts, pins, screws, or the like. In the embodiment shown in FIG. 5, the mounting strap 80 is attached to the track 20 at apertures 27, which run the length of the track and provide attachment points at the top and bottom ends of the track 20. Various different methods of attaching gas spring chamber 65 to track apparatus 20 could be used and are also encompassed by the present invention.

Decorative top cap 200 attaches to the top portion of the track 20. Such attachment can be through any conventional means. In one embodiment, the top cap 200 includes clips sized and positioned for insertion into the track channels 25. The pins can be sized to “snap” into place, thus forming a secure attachment. Secure attachment of the top cap can also be facilitated by forming the interior of the cap to tightly interact with the mounting strap 80. Similarly, the bottom cap 220 is attached to the bottom of the track 20 by any conventional means. In one embodiment, the bottom cap 220 is attached to the track 20 by screws that interact with the bottom end of the apertures 27.

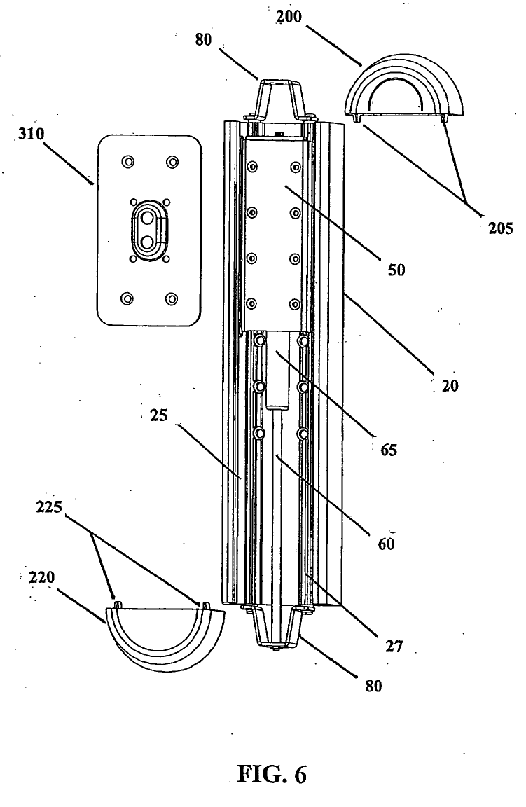

Another embodiment of the FEA of the invention is provided in FIG. 6, which shows a rear perspective view of the FEA. In this embodiment of the invention, the sliding bracket 50 still moves along track channels 25 but is arranged such that the sliding bracket flange (not shown in FIG. 6) is at the top of the sliding bracket 50. The sliding bracket 50 attaches to the top portion of the gas spring chamber 65. The bottom portion of the gas spring shaft 60 attaches to a mounting strap 80, which in turn attaches to the track 20. In this embodiment, the mounting strap 80 attaches to the track with screws that interact with the track apertures 27. The gas spring according to this embodiment of the invention could also be inverted.

In the embodiment of FIG. 6, a second mounting strap 80 is attached to the top portion of the track 20, and the presence of the mounting strap 80 is beneficial for facilitating secure attachment of the top cap 200 to the track 20. As seen in FIG. 6, the top cap further includes clips 205 for interacting with the track channels 25 to additionally secure the top cap 200 to the track 25. In this embodiment, the bottom cap 220 is similarly shaped as the top cap 200 and also includes clips 225 for facilitating attachment of the bottom cap 220 to the track 25. Again, the bottom cap 220 is preferentially structured internally to interact with the mounting strap 80 to further secure the bottom cap 220 to the track 20.

Also illustrated in FIG. 6 is a knuckle support mounting plate 310, which is particularly designed for attachment of the FEA to a support arm having an end for receiving the protruding element of the support mounting plate 310. As previously noted, multiple various support mounting plates can be used according to the various embodiments of the FEA of the invention.

In addition to the compression gas spring, additional motion regulating devices can be used in the front end height adjustment mechanism of the present invention. For example, the slide bracket could be attached to a simple screw mechanism that is mounted in the track apparatus such that manual adjustment of an actuator causes upward or downward movement of the attached video display. Further, the slide bracket could be allowed to move freely along the track apparatus and be externally secured in a given position with a friction generating mechanism, such as a bolt that can be manually tightened or loosened. Other methods of securing the slide bracket in a given position are also encompassed. For example, the track apparatus could have an incremental series of slots for receiving a projection from the slide bracket. Further, the gas spring could be replaced by a slide brake that includes a handle for releasing the brake temporarily to allow for upward or downward movement of the attached device.

The front end height adjustment mechanism of the invention is particularly adaptable for use in a variety of work or personal environments. As previously illustrated, the slide bracket is formed for attachment to a support device, either directly or through use of an additional support mounting bracket. Further, as previously illustrated, the FEA of the invention is formed on its front face for attachment of an input or display device, such as a video display, either directly or through the use of one or more display bracket and, optionally, a spacer bracket. Once attached to a support device and a desired input or display device, the front end height adjustment mechanism allows the user to easily adjust the height of the video display.

In some embodiments of the invention, the front end height adjustment mechanism is attached to a stationary support. For example, the FEA could be attached directly to a wall support (e.g., a stud or support beam) by attachment of the sliding bracket to the wall support. Alternately, the FEA could be attached to a stationary support pole or other stationary support member in a work environment. According to these embodiments, the FEA provides vertical positional adjustment of the desired device attached for use.

While the FEA mechanism of the invention finds particular use in a work environment, it is also useful for “at-home” and other personal environments. For example, it is particularly beneficial for home offices where space-saving and practical uses are desired. In a home computing setting, the FEA could be stationarily mounted to a wall support and a flat-screen monitor attached to the FEA. The computing desk is thereby freed from normal space consumption of the computer monitor, and the FEA allows for finger-touch height adjustment of the attached flat-screen monitor for use by various family members, including adults and children. Similarly, the FEA could be used for mounting a flat-screen television such that the television height could be adjusted with ease to suit the viewer.

The unique design of the front end height adjustment mechanism of the invention allows for both static and dynamic height adjustment. As previously noted, the front face of the FEA of the invention is formed with multiple apertures allowing for attachment of a device, such as a video display, at variable positions. Similarly, the sliding bracket is also formed with multiple apertures for attachment to a support device at variable positions. Accordingly, the FEA is capable of facilitating attachment of an input or display device to a support over a range of heights. The FEA generally provides for static height adjustment over a range of up to about 6 inches. In one particular embodiment, the FEA provides static height adjustment over a range of up to about 5 inches. Such static height adjustment is generally incremental based upon the spacing of the apertures on the front face of the track of the FEA and on the sliding bracket of the FEA.

In addition to the static height adjustment, the FEA of the invention also provides a user with dynamic height adjustment of the device attached to the FEA. As described in relation to the motion regulating device component of the FEA mechanism, dynamic height adjustment depends upon the type of motion regulating device used and the individual specifications of the motion regulating device. The FEA generally provides for dynamic height adjustment over a range of up to about 8 inches. In one particular embodiment, the FEA provides for dynamic height adjustment over a range of up to about 6 inches. Preferably, the dynamic height adjustment is continuous throughout the specified range.

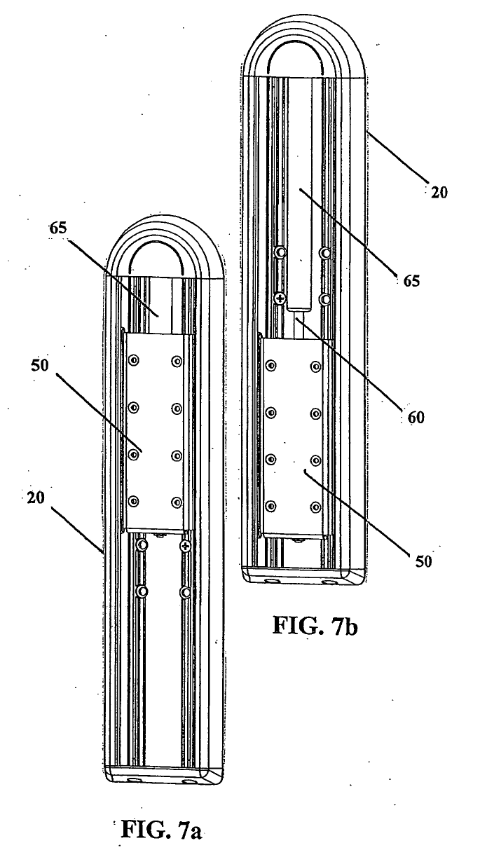

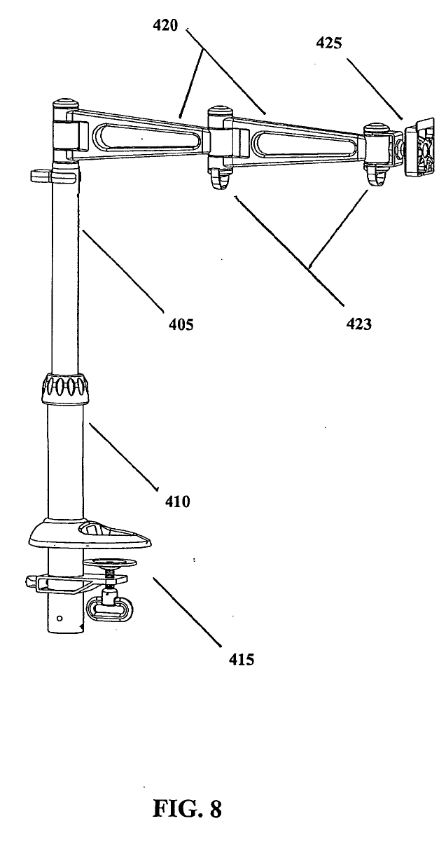

The dynamic height adjustment provided by the front end height adjustment mechanism of the invention is illustrated, in one embodiment, by FIG. 7a and FIG. 7b, both of which show one embodiment of the FEA incorporating a gas spring as the motion regulating device. In FIG. 7a, the gas spring is retracted (only the gas spring chamber 65 being visible), and the sliding bracket 50 is in an up position, being at the top portion of the track 20. In FIG. 7b, the gas spring is extended (the gas spring shaft 60 now being visible), and the sliding bracket 50 is in the down position, being near the bottom of the track 20. Assuming the sliding bracket is attached to a stationary support and a display device is attached to the front of the FEA, the attached display device would be in a lowered position according to FIG. 7a and would be in a raised position according to FIG. 7b.

According to further embodiments of the invention, the front end height adjustment mechanism can be used in association with further positional adjustment mechanisms. One such mechanism that is particularly useful in combination with the FEA is a device support arm. Device support arms (sometimes referred to as monitor arms) are useful in that they allow for positioning a display device (or an input device) some distance away from the support attachment point. This can be useful, for instance, to position the device away from obstacles, such as overhead shelving or other desktop items. Depending upon the monitor arm used, the attached device can be positioned at distances more than two feet away from the support attachment point. Furthermore, by including the FEA, the height adjustment mechanism remains directly behind the supported device, thereby providing for ease of height adjustment without requiring detachment and reattachment of any parts.

Preferentially, device support arms used according to the invention, in addition to allowing positioning away from the support attachment point, allow for lateral movement of the attached device, as well as depth adjustment. Furthermore, the monitor arms according to the invention can also allow for further vertical positioning of the attached device.

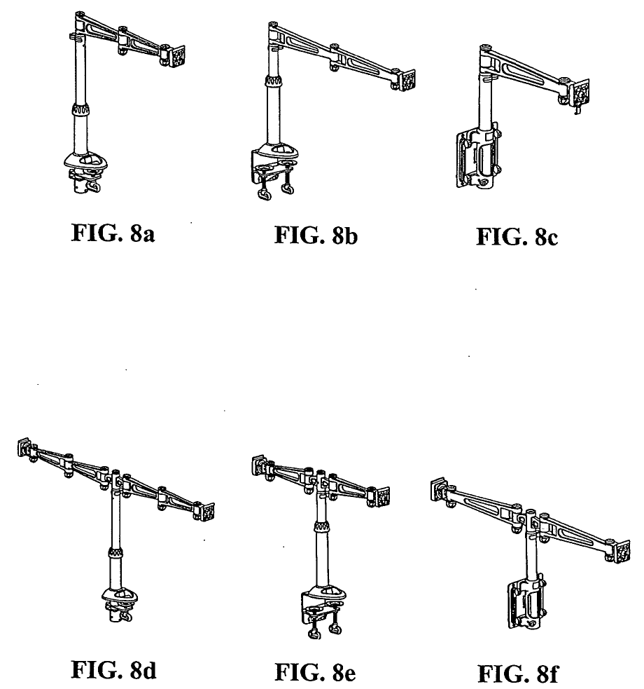

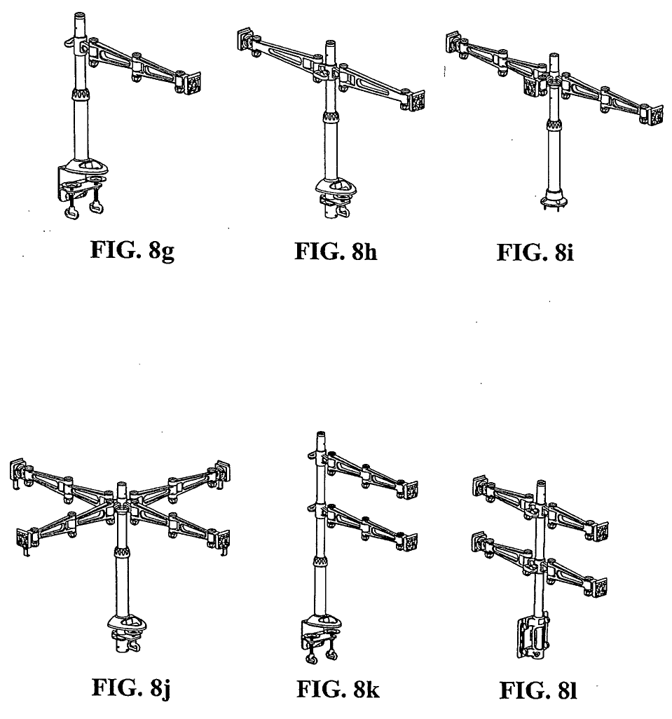

According to one embodiment of the invention, a device support arm particularly useful with the FEA is illustrated in FIG. 8. The support arm in this embodiment generally comprises a post 405, a gas cylinder 410, a mounting piece 415, one or more arm links 420, and a device attachment bracket 425. The support arm, particularly when used in combination with the FEA of the invention, provides effortless, three-dimensional adjustment to provide ideal positioning of various monitors and input devices for a number of different tasks and users. The support arm shown in FIG. 8 is available from Humanscale and is manufactured under the designation M7 Flat Panel Monitor Arms.

Various alternate embodiments of the support arm shown in FIG. 8 are also encompassed by the invention. In fact, the support arm is distinctive in its ability to be customized to meet a variety of device attachment needs. The support arm is thus capable of meeting a number of specific needs, including quick release, security, touchscreen attachment, rotation stop, and other special applications.

The support arm, as shown in FIG. 8, is characterized by a design that blends high functionality with pleasing aesthetics. The post design of the support arm maximizes space savings by occupying less space over a work surface, such as a desk. The post 405 provides for vertical adjustment of the support arm by moving within the gas spring 410. The gas spring allows for height adjustment with finger-touch movement, which minimizes risk of strain or other injury commonly associated with moving heavy object, such as monitors. The gas spring 410 is available in multiple options to support various monitor weights.

The length of the post 405 and the stroke of the gas spring 410 can vary such that varying distances of dynamic adjustment are available. In one particular embodiment, the post length and gas spring stroke are such that up to eight inches of dynamic height adjustment is provided. When used in combination with a FEA according to the invention, dynamic height adjustment up to about 16 inches can be provided. Such a range of dynamic adjustment allows a user to easily position an attached monitor for optimal comfort and ergonomic benefit relative the specific task being performed (e.g., leaning back, writing, or standing).

The support arm shown in FIG. 8 is also customizable in the type of mounting piece 415 used with the support arm. As shown in the embodiment in FIG. 8, the mounting piece 415 is a grommet style mounting piece. The various mounting options allow for quick and easy installation in any environment, such as attachment to a desk (including varying styles and thicknesses), counter, wall, or ceiling. The type of mounting piece used can affect dynamic adjustment and static adjustment of the support arm. For example, with the grommet style mounting piece, up to eight inches of dynamic height adjustment and up to six inches of static height adjustment are available in one embodiment. In another embodiment, the mounting piece is a clamp. In still another embodiment, the mounting piece is a ring bracket allowing direct attachment to a surface, such as with screws or bolts. In such embodiments, static height adjustment is generally unavailable, and dynamic height adjustment can be up to about three to four inches. In yet another embodiment, the mounting piece allows for attachment to a wall mounting surface, such as a slatwall configuration. In this embodiment, static adjustment is again unavailable, and dynamic height adjustment can be up to about three to four inches. In still another embodiment, the post and gas cylinder are absent, and the one or more arm links are attached directly to a wall through a fixed wall mount. In this embodiment, height adjustment is only available through use of the FEA mechanism of the invention.

As seen in the embodiment of FIG. 8, the support arm can include one or more arm links 420. The arm links can vary in length. Preferentially, when a plurality of arm links are used, each arm link is of the same length. In one embodiment, the arm link has a length of about eight inches. In another embodiment, the arm link has a length of about 12 inches. The combination of arm links generally allows for up to about 24 inches of depth adjustment with the support arm. The arm links are interconnected in a pivotal connection that allows the combination of arm links to partially fold up on itself. This allows for even greater positional adjustment control, particularly depth adjustment. The arm links 420 also can include one or more cable guides 423 that provide built-in cable management means to secure the power cables (as well as other cables inherent to the various electronic devices that may be used with the support arm) near the support arm to avoid cluttering the work area, to protect the cables, and to further enhance the aesthetics of the device.

The arm links are further pivotally attached to the post 405 of the support arm. The pivotal attachment can be through a top mount attachment, such as shown in FIG. 8, or through a bracket mount that allows for attachment of one or more arm links 420 at varying heights along the post 405.

The support arm of the embodiment shown in FIG. 8 also further includes a device attachment bracket 425, which is pivotally attached to the arm link 420. As seen in FIG. 8, the device attachment bracket 425 is a ball joint bracket that is a standardized 75 mm and 100 mm VESA bracket allowing for direct attachment of a monitor or input device. Other bracket types could be used to allow for attachment of even more devices. Further, the device attachment bracket 425 is useful for attachment of a FEA mechanism of the invention for facilitating even further height adjustment capability. The ball joint bracket design is particularly beneficial as it allows for up to a 60 degree range of monitor tilt (vertical or horizontal) for added adjustability. Further, the ball joint bracket allows for 360 degree monitor rotation to allow for either portrait or landscape viewing.

As previously noted, the support arm shown in FIG. 8 can take on a variety of customizable configurations to accommodate a variety of users, use environments, and attached devices. FIGS. 8a through 8l illustrate various specific embodiments of the M7 monitor arm.

FIGS. 8a through 8f illustrate monitor arms wherein the arm links are attached to the pole through a top mount pivotal attachment. FIG. 8a illustrates a monitor arm with one row of two standard length (eight inch) arm links and a grommet style mount device. FIG. 8b illustrates a monitor arm with one row of two long (twelve inch) arm links and a clamp mount. FIG. 8c illustrates a monitor arm with one long link, a slatwall mount, and a quick release tab on the ball joint bracket. FIG. 8d illustrates a monitor arm with one row of two standard links on the left and two standard links on the right. The monitor arm further includes a grommet style mount device. FIG. 8e illustrates a monitor arm with one row of arm links, comprising one standard arm link on the right and one standard arm link on the left. The monitor arm further includes a clamp mount. FIG. 8f illustrates a monitor arm with one row of arm links comprising one long arm link on the right and one long arm link on the left. The monitor arm further comprises a slatwall mount.

FIGS. 8g through 8l illustrate monitor arms wherein the arm links are attached to the pole through a bracket mount pivotal attachment at some point along the length of the pole. FIG. 8g illustrates a monitor arm with one row of two standard links and a clamp mount. FIG. 8h illustrates a monitor arm with one row of arm links comprising one long arm link on the right and one long arm link on the left. The monitor arm further comprises a grommet style mount. FIG. 8i illustrates a monitor arm with one row of arm links comprising two standard links on the right and two standard links on the left. The monitor arm further comprises a ball joint with no arm links attached to the pole and a direct mount ring bracket attachment device. FIG. 8j illustrates a monitor arm with four sets of standard arm links at the same vertical position on the pole. The monitor arm further comprises a grommet mount. FIG. 8k illustrates a monitor arm with two rows of two standard arm links and a clamp mount. FIG. 8l illustrates a monitor arm with two rows of arm links comprising one standard arm link in each row on the right and one standard arm link in each row on the left. The monitor arm further comprises a slatwall mount.

Even further additional configurations in addition to those described above in relation to the monitor arm illustrated in FIGS. 8 through 8l are also encompassed by the present invention. Moreover, the present invention also encompasses other types of monitor arms for use in facilitating the positional adjustment of an attached device, such as a monitor.

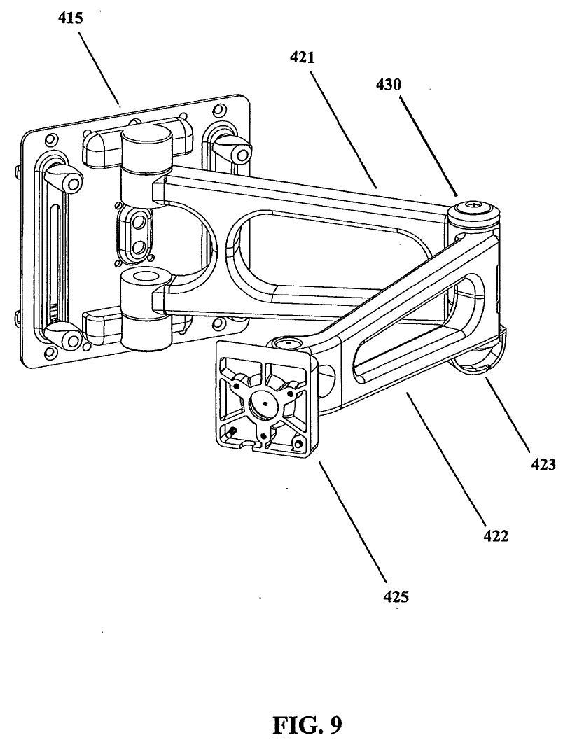

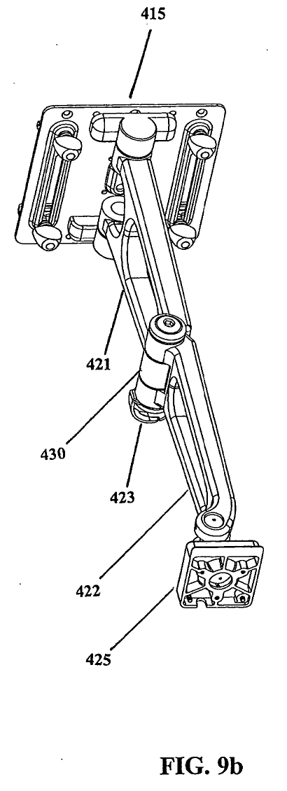

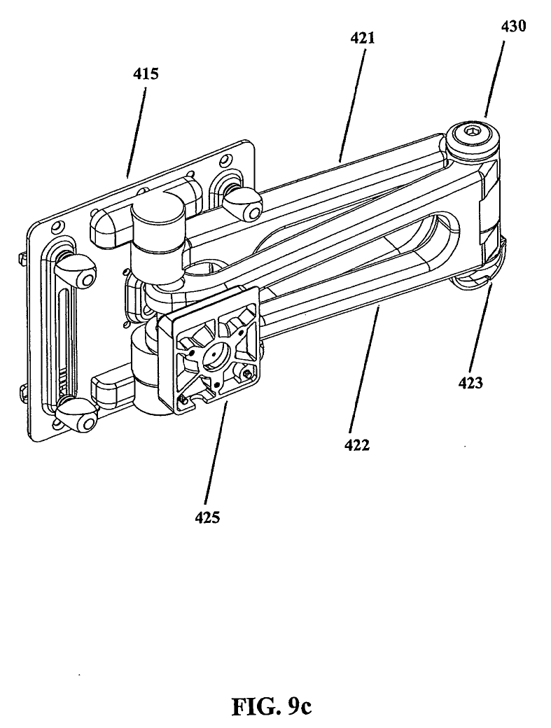

According to another embodiment of the invention, there is provided a device support arm adaptable for attachment at one end to a stationary support and adaptable for attachment at the opposite end to a device, such as a monitor or an input device. In one particular embodiment, as seen in FIG. 9, the device support arm comprises a rear arm link 421, a front arm link 422, an offset pivot attachment 430 connecting the front arm link 422 to the rear arm link 421, a support attachment bracket 415 pivotally connected to the rear arm link 421, and a device attachment bracket 425 pivotally attached to the front arm link 422.

The unique offset pivot attachment 430 used to connect the front arm link 422 and the rear arm link 421 is particularly beneficial in that it allows for folding of the device support arm from a fully extended position to a fully folded position wherein the device support arm is substantially flattened. Such movement is more clearly illustrated in FIGS. 9b and 9c.

The device support arm is shown fully extended in FIG. 9c. In such a position, the device support arm is capable of supporting an attached device at a maximum distance away from a stationary support, to which the support attachment bracket 415 would be connected. In this position, the rear arm link 421 and the front arm link 422 are aligned in a straight line. The nature of the offset pivot attachment 430 is readily seen in FIG. 9b, as the pivot attachment 430 is slightly offset from the alignment of the rear arm link 421 and the front arm link 422.

Previously known monitor arms have pivotal attachments between arm links that are substantially aligned with the individual arm links. Such alignment disallows full collapse of the arm links. In other words, when the arm is folded (in previously known monitor arms), the arms reach a point, at some distance prior to being fully folded such that the arm links are flat together, wherein the support arm can no longer fold. Such a limitation, however, is overcome by the device support arm of the present invention.

As can be seen in FIG. 9c, the design of the offset pivot attachment 430 allows the front arm link 422 to fully fold against the rear arm link 421 such that the front arm link 422 is positioned adjacent the rear arm link 421 in a substantially flattened state. This is highly beneficial in that it allows for a dramatically increased range of movement for a device attached to the device attachment bracket 425 that has heretofore not been achieved. Through use of the device support arm according to this embodiment of the invention, it is possible to allow for lateral adjustment and depth adjustment of an attached device. Accordingly, an attached device can be extended away from a stationary support the full length of the fully extended device support arm of the invention but can also be positioned out of the way, when desired, to be substantially flattened against the stationary support. This is possible due to the unique design and incorporation of the offset pivot attachment 430 in the device support arm.

The arm links themselves are characterized in this embodiment in that the rear arm link 421 is greater in length than the front arm link 422. The arm links can vary in length; however, it is preferable that the rear link be greater in length than the front link. This further enables the device support arm to fold upon itself to a substantially flattened state.

According to another particular embodiment of the invention, the offset pivot attachment 430 includes a locking mechanism such that when fully extended, the arm links are locked to prevent unintentional folding of the arm links. Mechanisms capable of providing such a locking function are known in the art, and any of such mechanisms are fully envisioned as useful in the present invention. Particularly, the locking mechanism is internal to the offset pivot attachment and includes mechanism wherein a lock bar is biased to engage a lock recess. The biasing mechanism, such as a spring, provides sufficient force to prevent unintentional folding of the device support arm but is minimal enough to allow the lock bar to be disengaged from the lock recess by manual folding of the arm by a user. The monitor arm in this embodiment can further comprise one or more cable guides 423 for facilitating cable management.

As shown in FIGS. 9 through 9c, the rear arm link 421 is pivotally attached directly to the mounting piece 415. In this embodiment, the mounting piece 415 is a slatwall mount. In further embodiments, the rear link 421 can be pivotally attached to additional mounting arm components to allow for even more positional adjustment of an attached device. For example, in one embodiment, the rear link 421 is pivotally attached to a pole, such as the post 405 illustrated in FIG. 8. Such attachment could be through a top mount pivotal attachment (similar to that illustrated in FIGS. 8a through 8f. Furthermore, such attachment could be through a bracket mount pivotal attachment (similar to that illustrated in FIGS. 8g through 8l). Still further, such attachment of the device support arm to a post could be through other means, as described herein.

When the rear arm link is attached to a post, the post can be mounted directly to a support, such as through a slatwall mount or a ring mounting bracket. Furthermore, the mounting arm can include a gas spring component to allow for even greater control of the positional adjustment and to provide dynamic height adjustment capabilities. When a gas spring is used, mounting of the device support arm can be through various mounting pieces, similar to those illustrated in FIGS. 8a through 8l.

In one particular embodiment, the rear arm link 421 and the front arm link 422 illustrated in FIG. 9 are incorporated into the monitor arm illustrated in FIG. 8, replacing the arm links illustrated in FIG. 8, or being used in addition to the arm links illustrated in FIG. 8 to provide for attachment of a plurality of devices. Accordingly, the device support arm of the embodiment illustrated in FIG. 9 can be described in terms similar to that described above in reference to the various embodiments of FIG. 8, particularly relating to the ability to provide varying static and dynamic height adjustment, depth adjustment, lateral adjustment, rotational adjustment, and tilt adjustment.

As further shown in FIG. 9, the device support arm also comprises a device attachment bracket 425. The device attachment bracket illustrated in FIG. 9 is a ball joint bracket as described above in reference to FIG. 8. Again, various additional brackets could be used to facilitate attachment of a number of different devices, and such additional brackets are also encompassed by the present invention.

In a preferred embodiment, the device support arm of the embodiment shown in FIG. 9 is attached to the FEA mechanism of the invention, and the monitor (or other device) is attached to the FEA. This can encompass various embodiments as the device support arm can take on various configurations as described above. Accordingly, varying levels of positional adjustment can be achieved. In particular, height adjustment is greatly facilitated (both static and dynamic), especially as provided for by the FEA of the invention.

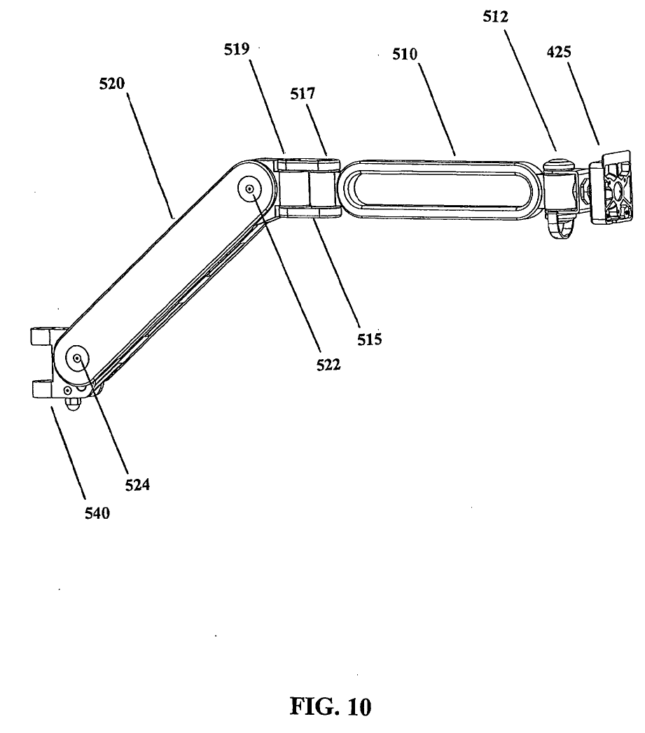

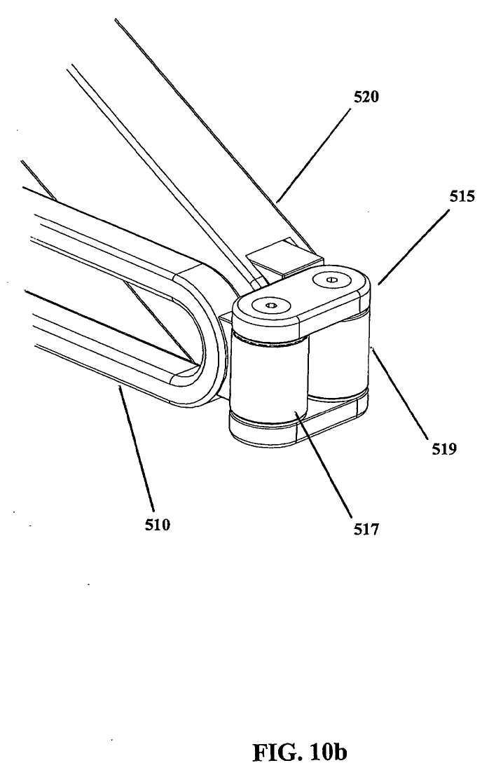

In yet another embodiment according to the present invention, there is provided a device support arm that is particularly useful for facilitating positional adjustment of an attached device. As illustrated in FIG. 10, in one specific embodiment, the device support arm comprises a horizontal arm 510, a parallelogram arm 520, a dual pivot attachment 515 connecting the horizontal arm 510 to the parallelogram arm 520, a device attachment bracket 425 pivotally attached to the horizontal arm 510, and a support attachment bracket 540 pivotally attached to the parallelogram arm 520.

The device attachment bracket 425 is pivotally attached to the horizontal arm 510 at a horizontal arm front pivot 512. As shown in FIG. 10, the device attachment bracket 425 is a ball joint type bracket with standardized VESA 75 mm and 100 mm attachment. Such attachment bracket is preferred for the versatility it provides with rotational and tilt adjustment, as well the ability to attach a large number of monitors or input devices. In particular, the device attachment bracket 425 is useful for attaching a FEA device of the present invention.

The device support arm according to this embodiment of the invention is particularly characterized in that the horizontal arm 510 is attached to the parallelogram arm 520 with the dual pivot attachment 515. The dual pivot attachment 515 is unique in its ability to allow for rotation of the horizontal arm 510 in a horizontal plane through a range of approximately 360°. In other words, from a straight, fully extended position, the horizontal arm 510 can laterally pivot approximately 180° to the left and can laterally pivot approximately 180° to the right. Such range of motion is provided in that the dual pivot attachment 510 comprises a front horizontal pivot 517 attached to the horizontal arm 510 and a rear horizontal pivot 519 attached to the parallelogram arm 520, both pivots being in connection as part of the dual pivot attachment 515, and both pivots pivoting in the same plane.

The dual pivot attachment 515 is more clearly shown in FIG. 10b, which provides a cut-away view of the device support arm in a folded position. As a comparative, FIG. 10 shows the device support arm in an extended position. In FIG. 10, the parallelogram arm 520, the horizontal arm 510, the rear horizontal pivot 519, and the front horizontal pivot 517, are aligned in the same vertical plane. In the folded position, as shown in FIG. 10b, the horizontal arm 510 has pivoted 90° at the front horizontal pivot 517, and the dual pivot attachment 515 has pivoted 90° in the same direction at the rear horizontal pivot 519. Accordingly, the horizontal arm 510 has pivoted 180° from the extended position (FIG. 10) to the folded position (FIG. 10b).

Identical movement to the opposite side of the device support arm of this embodiment of the invention is also possible.

The parallelogram arm 520 is attached (at its front portion), through a front parallelogram pivot bracket 522, to the rear horizontal pivot 519, and is further attached (at its rear portion), through a rear parallelogram pivot bracket 524, to the support attachment bracket 540. Various further attachments could also be used with the device support arm to allow for attachment to multiple different types of supports. In the embodiment shown, the support attachment bracket 540 is particularly adapted for attachment to a post (such as that illustrated in FIG. 8). Furthermore, the support attachment bracket 540 can be attached directly to a mounting bracket (similar to the monitor arm embodiment illustrated in FIG. 9). Still further, the parallelogram arm 520 could itself be directly attached to a different kind of mounting bracket for attachment to a support, such as a desk, a wall, or a modular-type support. Accordingly, the device support arm, as illustrated in the embodiment of FIG. 10, can be incorporated into a variety of setups for facilitating positional adjustment of a viewing device, such as a monitor, or an input device.

Similar to the monitor arm embodiments described above, the device support arm illustrated by the embodiment of FIG. 10 allows for three dimensional adjustment to provide ideal monitor positioning for different tasks and users. The device support arm can provide up to 24 inches of depth adjustment, allows for dynamic height adjustment and static height adjustment, provides 360° monitor rotation for portrait or landscape viewing, and provides a 60° range of monitor tilt.

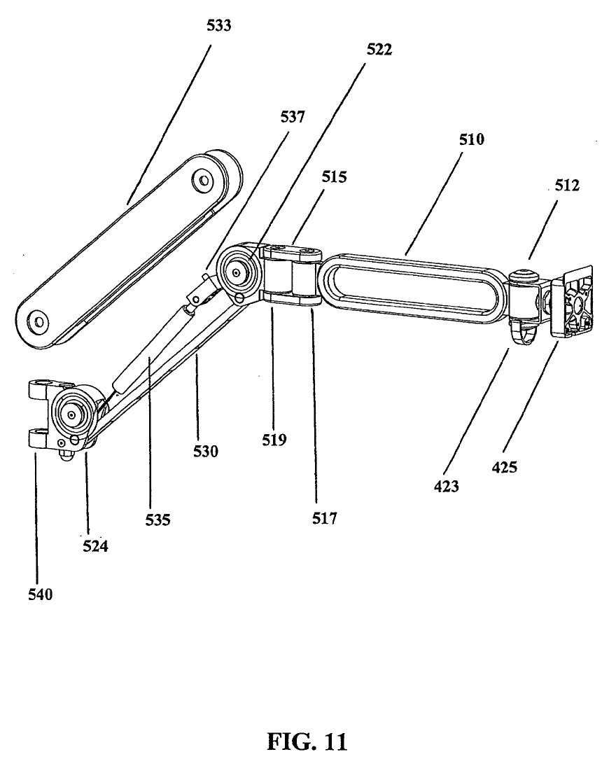

The embodiment of the device support arm of FIG. 10 is further illustrated in FIG. 11, which shows a partially exploded view of the parallelogram arm 520. As seen in FIG. 11, the parallelogram arm comprises a lower arm bar 530 and an upper arm bar 533 (which also functions as a casing for the parallelogram arm to cover the moving components of the parallelogram arm and to protect from interference by, or injury to, a user during dynamic height adjustment of the monitor arm). The parallelogram arm further comprises a motion-regulating device that allows for dynamic movement of the monitor arm in a vertical direction but also functions to maintain a given vertical position once dynamic adjustment by a user has stopped. In the embodiment shown in FIG. 11, the motion-regulating device is a gas spring 535. Preferably, the gas spring 535 is capable of load adjustment such that the device support arm can be easily modified to support devices over a varying range of weights. In a preferred embodiment, the gas spring 535 is adjustable to hold devices having a weight of up to about 30 pounds.

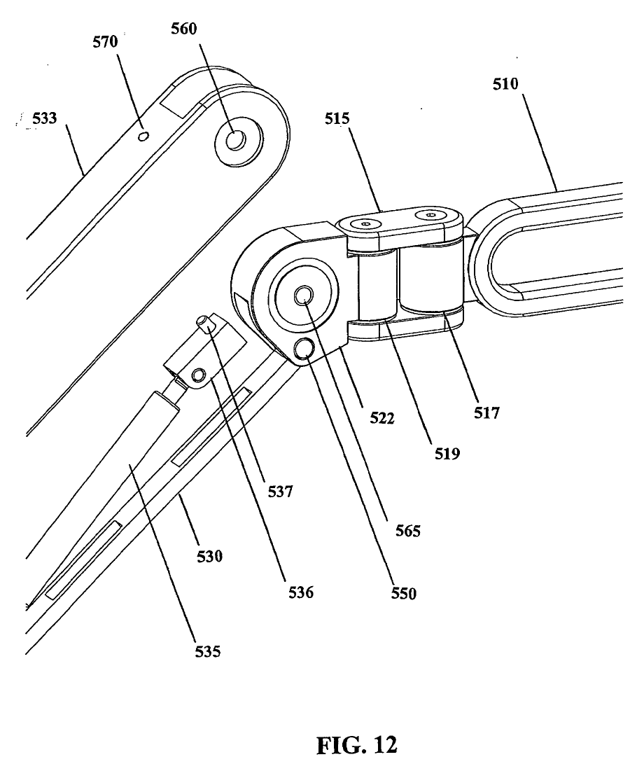

The lower arm bar 530 of the parallelogram arm is pivotally attached to the front parallelogram pivot bracket 522 and is pivotally attached to the rear parallelogram pivot bracket 524. In one embodiment, the rear pivot bracket 524 and the support attachment bracket 540 are a single integral piece. The linkage between the horizontal arm 510, the horizontal pivot piece 515, the front parallelogram pivot bracket 522, the lower arm bar 530, and the upper arm bar 533 is shown in greater detail in FIG. 12. As can be seen in this embodiment, the front parallelogram pivot 522 is attached to the rear horizontal pivot, thereby linking the horizontal arm 510 to the parallelogram arm 533. The front parallelogram pivot bracket 522 further comprises components for facilitating pivotal attachment of the lower arm bar 530 and the upper arm bar 533. In this embodiment, the front parallelogram pivot bracket 522 comprises an aperture 565 for receiving an attachment device, such as a screw, bolt, or pin, for attachment of the upper arm bar 533. Accordingly, the upper arm bar 533 further comprises a pivot attachment aperture 560 through which the screw, bolt, pin, etc. can pass into the aperture 565 on the parallelogram pivot bracket 522. Also in this embodiment, the front parallelogram pivot bracket 522 comprises an aperture for receiving an attachment device (such as a screw, bolt, or pin) to pivotally attach the lower arm bar 530 to the front parallelogram pivot bracket 522. As shown in FIG. 12, the attachment device is a pin 550.

In FIG. 12, the front end of the gas spring 535 appears for float free; however, in a fully constructed monitor arm according to this embodiment, the gas spring is actually attached to the upper arm bar 533, thereby facilitating a parallelogram linkage between the upper arm bar 533 and the lower arm bar 530. As can be seen in FIG. 12, the gas spring 535 comprises a front gas spring bracket 536 pivotally attached to the front end of the gas spring 535. The front gas spring bracket 536 includes a pin 537 for interacting with an aperture 570 in the top surface of the upper bar 533, thereby attaching the gas spring 535 to the upper arm bar 533.

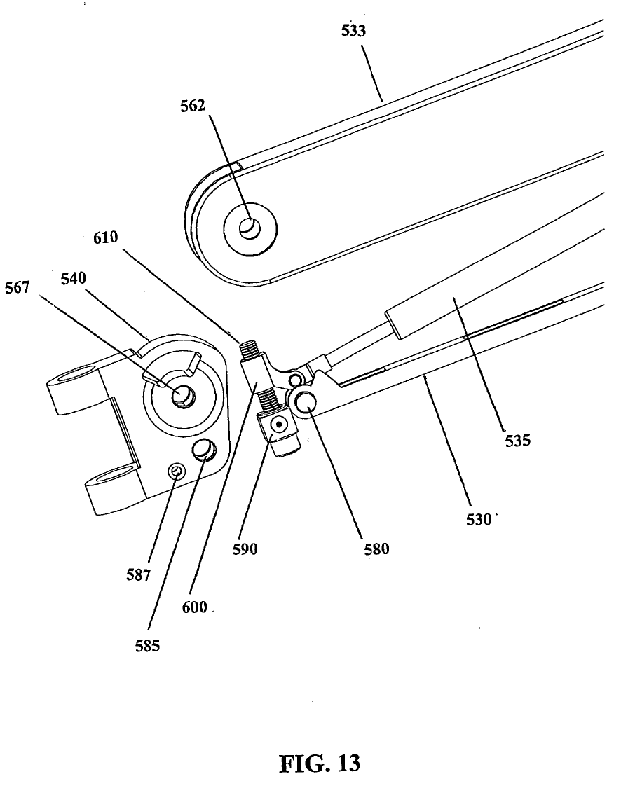

FIG. 13 provides a more detailed view of the attachment of the parallelogram arm 520 to the support attachment bracket 540, according to one embodiment of the invention. In this embodiment, the upper arm bar 533 and the support attachment 540 have been moved out of their normal position to better reveal the underlying components. Additional components seen in this view include a gas spring attachment bolt 610 and a rear gas spring bracket 600. The gas spring 535 pivotally attaches to the rear gas spring bracket 600, which is adjustably positioned on the attachment bolt 610. In turn, the gas spring attachment bolt 610 is secured to the support attachment 540 with an attachment piece (such as a screw, bolt, pin, or the like) through an aperture 587 in the support attachment 540 and through an aperture in the bolt frame piece 590.

The lower arm bar 530 likewise pivotally attaches to the support attachment 540 with an attachment piece (such as a screw, bolt, pin, or the like) through an aperture 585 in the support attachment 540 and through an aperture in the lower arm bar 530. The upper arm bar 533 also attaches to the support attachment 540 with an attachment piece through an aperture 562 in the upper arm bar 533 and through an aperture 567 in the support attachment piece 540. Again, such attachment facilitates a parallelogram linkage between the upper arm bar 533 and the lower arm bar 530. Preferably, one or more spacer pieces, such as a washer, are used in the attachment of the upper arm bar 533 to the support attachment 540. Further preferably, an aperture lining, such as a bushing, is used in the aperture 567 in the support attachment to facilitate free movement of the parallelogram arm 520 during positional adjustment of the monitor arm.

The device support arm illustrated in the embodiments of FIGS. 10 through 13 is particularly useful for providing dynamic height adjustment of an attached device, such as a monitor or an input device. The length of the parallelogram arm and the horizontal arm can vary and thereby provide various embodiments wherein the range of height adjustment available can also vary. In one embodiment, the parallelogram arm has a length of about 10 inches. In another embodiment, the horizontal arm has a length of about 10 inches. In one particular embodiment, both the parallelogram arm and the horizontal have a length of about 10 inches. In this embodiment, the device support arm can provide up to abut 14 inches of dynamic height adjustment. Further, depending upon the type of attachment (i.e., stationary, such as with a slatwall mount, or moveable, such as with a post and grommet mount), the device support arm in this embodiment of the invention can also provide up to about 6 inches of static height adjustment.

Preferably, the device support arm illustrated in the embodiments of FIGS. 10 through 13 is used in combination with the FEA mechanism of the invention. In such a combination (particularly when the device support arm further includes a post with height adjustable mount), a maximum level of position adjustment is provided to a user with a variety of devices that can be attached to the FEA. In this embodiment, height adjustment is provided with the device support arm itself, but an additional distance of height adjustment is also provided by the FEA, which is optimally position directly behind the attached device, such as a monitor. For example, static height can be adjusted to a preferably range (in both the FEA and the monitor arm) depending upon the environment in which the monitor is being used. The FEA provides dynamic height adjustment (i.e., “fine tuning” height adjustment) over a range of about 6 inches whereby preferred height for a number of users can be obtained. Further, the device support arm offers additional height adjustment over a range of about another 14 inches. In this combination, a preferred height for practically any environment and any use can be obtained with a single monitor attachment setup.

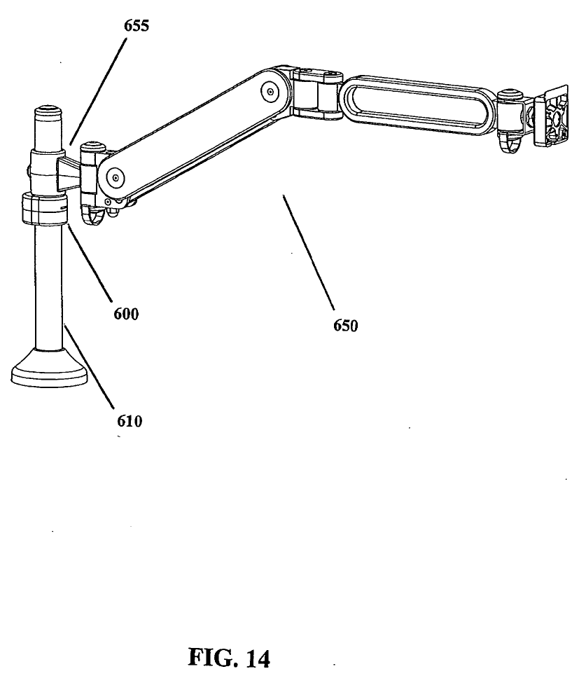

According to another aspect of the invention, there is provided a knobless bracket useful for securing a device to a support post. In particular, the bracket of the invention is useful for securing a device support arm, such as those described herein, at a specific position vertically on a support post. The bracket is particularly useful for its sleek, compact design and ease of use. The bracket is capable of securing the device support arm at a specific height (i.e., disallows the arm from sliding down the post), and the height can be readily adjusted by gripping the bracket and sliding up or down the post. Accordingly, there is no need for bulky, obtrusive bolts, screws, switches, levers, knobs, or other additional adjustment facilitating devices. Rather, the adjustment is internal to the bracket. The function of the bracket is shown in FIG. 14. In the embodiment shown therein, the knobless bracket 600 is positioned on a post 610. A device support arm 650 according to the invention is attached to the post 610 with a free sliding bracket 655. The free sliding bracket 655 is prevented from sliding down the post by the presence of the knobless bracket 600. Accordingly, repositioning of the device support arm 650 on the post 610 is facilitated by squeezing the bracket and manually sliding the knobless bracket 600 and the free sliding bracket 655 (and necessarily the device support arm 650) to the desired height on the post 610.

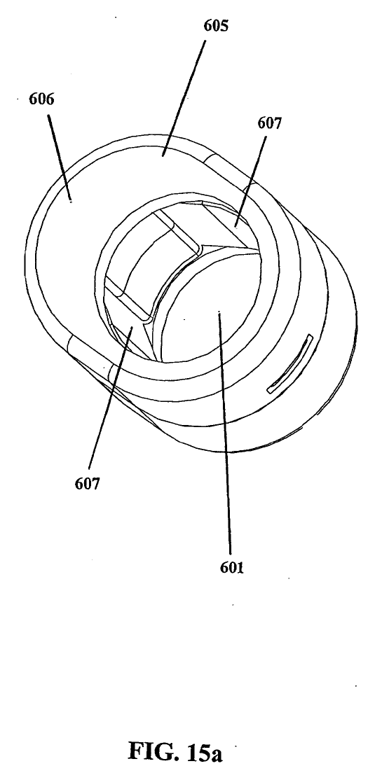

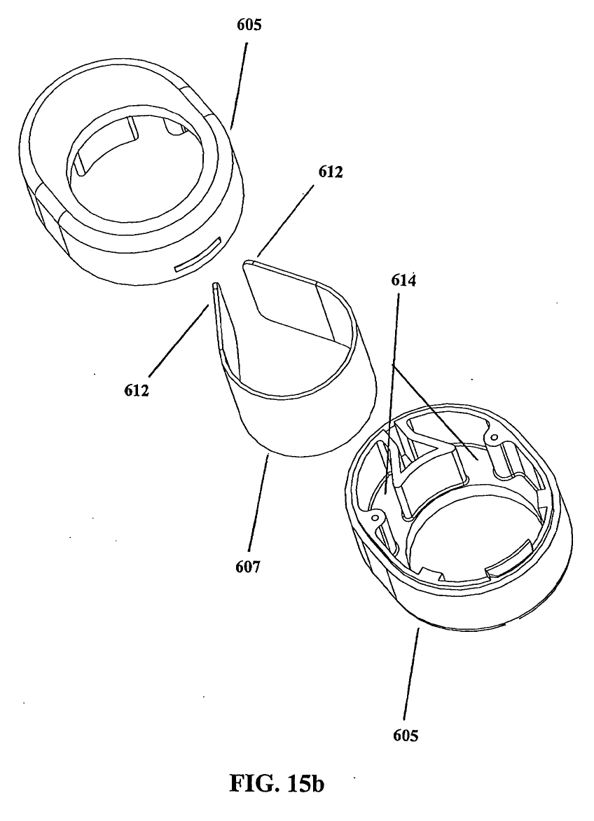

In one embodiment of the invention, as illustrated in FIGS. 15a and 15b, the bracket comprises a compressible ring-shaped cover 605 having an oblong end 606 and having a central opening 601 extending through the cover. Internal to the cover 605 is a flattened steel spring 607 that is rounded such that that the two free ends 612 of the steel spring 607 are in close proximity to each other. The steel spring 607, while rounded, is substantially oblong shape. As visible in FIG. 15a, the steel spring 607 is biased along the sides thereof toward the central opening 601 in the cover 605. Accordingly, when the bracket 600 is on a post (e.g., a post is extending through the central opening 601 in the bracket 600, as in FIG. 14), the spring 607 presses against the post providing a gripping force directed toward the central opening 601, and subsequently against the post.

As seen in the exploded view of FIG. 15b, the free ends 612 of the steel spring 607 fit into formed recesses 614 in the oblong end 606 of the cover 605. Compression of the oblong end 606 of the cover 605 provides pressure on the steel spring 607 forcing the steel spring 607 to take on a more rounded shape, therefore releasing the gripping force of the spring 607 on the post.

Preferably, the cover of the knobless bracket is comprised of a resilient material that is compressible to a degree necessary to the release the gripping force of the internal steel spring but rigid enough to resist damage. Alternately, the sides of the bracket can include sliding junction allowing the oblong end of the bracket to slide toward the opposite end of the bracket when compression is applied by a user. Other similar types of construction allowing for the function of the bracket, as described herein, are also encompassed by the invention.

As would be readily envisioned by one of skill in the art, the various mechanisms described herein are particularly useful in combination for providing functional, attractive support mechanisms that allow for easy position adjustment of attached devices. All combinations of the multiple mechanisms describe herein are therefore encompassed by the present invention.

Preferentially, the various components of the present invention, including the FEA mechanism, as well as the various device support arm embodiments, are constructed generally out of a strong, lightweight material, such as aluminum. Various different materials could also be used, such as other metals or plastics.

Many modifications and other embodiments of the inventions set forth herein will come to mind to one skilled in the art to which these inventions pertain having the benefit of the teaching presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1-35. (canceled)

36. A mechanism for adjusting the height of an attached device, the mechanism comprising:
a track;
a sliding bracket operably engaged to the track and adaptable for movement along the track such that the height of the device may be adjusted dynamically by movement of the sliding bracket; and
a plurality of motion regulating devices operably engaged with the track, a force exerted on the sliding bracket by the plurality of motion regulating devices being adjustable.

37. A mechanism for adjusting the height of an attached device, the mechanism comprising:
a track;
a sliding bracket operably engaged to the track and adaptable for movement along the track such that the height of the device may be adjusted dynamically by movement of the sliding bracket; and
a plurality of motion regulating devices operably engaged with the track.

38. The mechanism according to claim 37, wherein the plurality of motion regulating devices are operably engaged with the sliding bracket.

39. The mechanism according to claim 37, wherein the sliding bracket is adaptable for attachment to a support structure.

40. The mechanism according to claim 39 further comprising an additional bracket, wherein the additional bracket is adaptable for attachment to the device.

41. The mechanism according to claim 40, wherein the additional bracket faces opposite the sliding bracket.

42. The mechanism according to claim 37, wherein the plurality of motion regulating devices are attached at one end to the track and attached at an opposite end to the sliding bracket.

43. A mechanism for adjusting the height of an attached device, the mechanism comprising:
a track;
a sliding bracket operably engaged to the track and adaptable for movement along the track such that the height of the device may be adjusted dynamically by movement of the sliding bracket; and
a motion regulating device operably engaged with the sliding bracket, a force exerted on the sliding bracket by the motion regulating device being adjustable.

44. The mechanism according to claim 43, wherein the sliding bracket is adaptable for attachment to a support structure.

45. The mechanism according to claim 44 further comprising an additional bracket, wherein the additional bracket is adaptable for attachment to the device.

46. The mechanism according to claim 45, wherein the additional bracket faces opposite the sliding bracket.

47. The mechanism according to claim 43, wherein the motion regulating device is attached at one end to the track and attached at an opposite end to the sliding bracket.

48. The mechanism according to claim 43, wherein the motion regulating device comprises a plurality of motion regulating devices.
